(19) United States
(12) Patent Application Publication
(10) Pub. No.: US 2024/0241894 A1
(43) Pub. Date: Jul. 18, 2024

(54) VIRTUAL COMPUTATION AND CONTROL SYSTEM FOR AGGREGATION AND CATEGORIZATION OF GEOGRAPHIC DATA

(71) Applicants: Susan Lynn Schopp, San Antonio, TX (US); Jeffrey Kyle Schopp, San Antonio, TX (US); John Edward Schopp, San Antonio, TX (US)

(72) Inventors: Susan Lynn Schopp, San Antonio, TX (US); Jeffrey Kyle Schopp, San Antonio, TX (US); John Edward Schopp, San Antonio, TX (US)

(21) Appl. No.: 18/411,619

(22) Filed: Jan. 12, 2024

Related U.S. Application Data
(60) Provisional application No. 63/438,890, filed on Jan. 13, 2023.

(51) Int. Cl. G06F 16/29; G06F 16/2455; G06F 16/27

(52) U.S. Cl. CPC G06F 16/29; G06F 16/24556; G06F 16/27

(57) ABSTRACT

This disclosure is directed to a virtual computation and control systems utilizing aggregated disparate data in a complex computing network in order to virtually control data and associated physical embodiments. The virtual computation and control system provides an improved environment for establishing user-friendly interfaces with efficient communication structures and control features oriented towards users' interests is needed. The virtual computation and control system may comprise a hardware data communication interface, a hardware digital processor, and a hardware user interface.

### CROSS REFERENCE TO RELATED APPLICATION

The present application claims priority to U.S. Provisional Application No. 63/438,890, filed Jan. 13, 2023, the entire contents of which is incorporated herein by reference.

### BACKGROUND

There is a need for virtual computation and control systems to utilize aggregated disparate data in a complex computing network in order to virtually control data and associated physical embodiments. Differing, older systems are often costly, overly focused on revenue, accompanied by conflicts of interest between system controller and users, and lacking in efficient communication structures. A virtual computation and control system that provides an improved environment for establishing user-friendly interfaces with efficient communication structures and control features oriented towards users' interests is needed.

### BRIEF DESCRIPTION OF THE DRAWINGS

The disclosure is illustrated by way of example, and not by way of limitation in the figures of the accompanying drawings in which like reference numerals are used to refer to similar elements. The various elements shown in the figures that follow may be optional depending on a given embodiment without departing from the principles provided in this disclosure.

FIG. 1 is a network diagram for executing any methods described herein, in accordance with some embodiments of the disclosure.

FIG. 2 is a high-level network system for accessing, managing, and sharing structured data, according to one embodiment.

FIG. 3A is a functional block diagram of a computing environment for accessing and visualizing structured data, according to one embodiment.

FIG. 3B is a detailed system diagram of FIG. 3A, according to one embodiment.

### DETAILED DESCRIPTION

For the purposes of promoting an understanding of the principles of the disclosure, reference is made to selected embodiments illustrated in the drawings and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in art to which the disclosure relates. At least one embodiment of the disclosure is shown in detail, although it will be apparent to those skilled in the relevant art that some features or some combinations of features may not be shown for the sake of clarity.

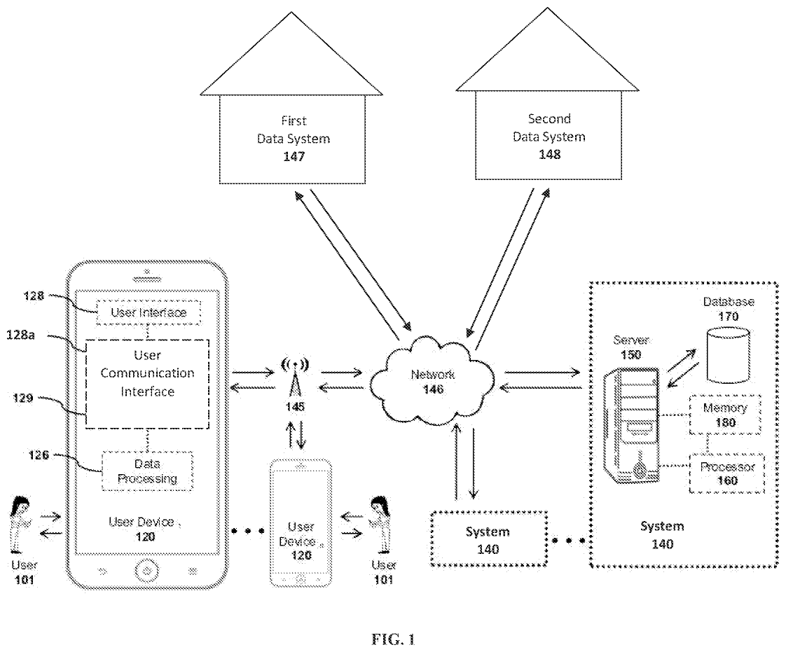

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present disclosure, other embodiments may not include those same advantages, or may include different advantages. Any advantages described herein are not to be construed as limiting to any of the claims. FIG. 1 describes a schematic block diagram of a network system for reducing time and memory usage associated with computing operations. While the user device 120 is shown as a mobile phone, in other embodiments, the user device 120 may be any other mobile or non-mobile computing device, including Internet of Things (IOT) devices. The illustrated network 146, such as the internet or an intranet, can be used to exchange data between the first data system 147, second data system 148, server 150 and the user device 120.

According to some embodiments, a user 101 and/or another computer interacts with the disclosed systems for determining a subset from a set according to the methods disclosed herein. Disclosed user devices 120 may include computing device capable of sending data and communicating over the internet with one or more servers 150, other user devices 120, or other type of computing devices. The methods described herein may be executed by at least one of the user device 120 (e.g., using the user communication interface 128a and data processing 126 systems), the server 150 (e.g., using the processor 160), or a combination of both.

A wireless communications network 145 may be a 3G network, 4G, LTE, 5G, Wi-Fi, Bluetooth, or any other network protocol and may be a combination of any number of networks. Further, as mentioned above a wired network connection such as a conventional Ethernet connection could be used, such as with a personal computer with an Ethernet port. User devices 120 or servers 150 may include processors 430 such as digital signal processors or a microprocessors for performing the different methods described in this specification.

Although the servers 150 illustrated in the present figure are illustrated as stand-alone computing machines, the computing functionality, including servers 150, processors or processor instances 160, memory or computing data storage areas 180, and databases 170 can be provided through a cloud implementation such as Amazon Web Services or by a hybrid enterprise/cloud architecture. It is understood that the terms system, apparatus, device, etc. may be used interchangeably in this specification. In some embodiments, a method is provided for performing the various steps performed by any computing device, e.g. user device 120 and/or server 150, described herein. In some embodiments, a non-transitory computer-readable medium comprising code is provided for causing any user device 120, computing device, or server 150, to perform the various methods described herein. The scope of any claims that may be a part of this application or any application stemming from the present application shall be determined by those claims as read in light of the claims, but the elements of the particularly illustrated embodiments shall not be imputed to the claim language unless particularly invoked through the use of means-plus-function language under 35 U.S.C. Section 112(f).

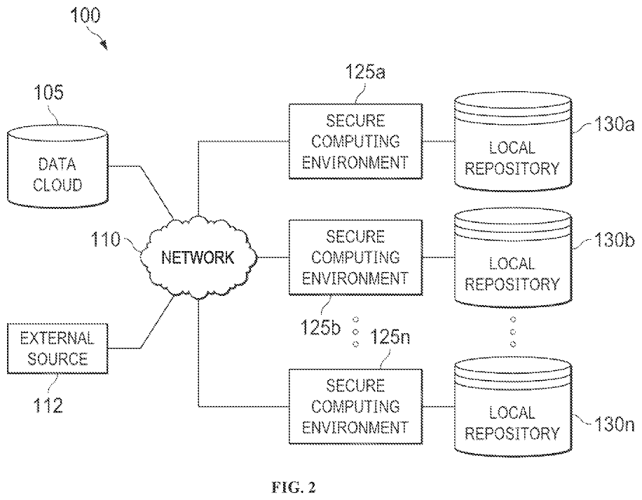

Illustrated in FIG. 2 is a high level network system 100 for generating interfaces that access, maintain, analyze, and display structured data. In the depicted implementation, the system 100 may include a data cloud server 105 communicatively coupled to a plurality of secure computing environments 125 external sources 112 via the network 110. The secure computing environments 125 may in turn be communicatively coupled to a local repository 130. While a single data cloud server 105 is illustrated, the disclosed principles and techniques could be expanded to include multiple data cloud servers 105.

The data cloud server 105, according to some embodiments, is configured to store a plurality of structured data in a secure environment requiring authentication before access is granted to the structured data. According to one implementation, the structured data includes hierarchical data having varying and connected categories/levels that describe a plurality of aspects of the structured data. In some cases, the structured data in the data cloud server 105 is sourced or obtained from third-party scientific sources, and/or from third-party regulatory agencies, and/or from academic sources, and/or from industrial sources, etc.

In addition, the data cloud server 105 may be configured to manage or otherwise maintain the integrity and/or version updates of the structured data so that a user (e.g., a user of the secure computing environment) does not have to deal with such data maintenance processes as the structured data changes and/or grows. In one embodiment, the data cloud server 105 provides the most current version of the structured data to a user of the system. In other embodiments, the data cloud server 105 can also provide historical versions of the structured data when necessary or needed. Furthermore, the data cloud server 105 may include mechanisms that execute operations of data decompression operations, data decryption operations, and data decoding operations associated with the structured data so that the user is effectively isolated from such operations.

Moreover, the data cloud server 105 allows for easy associating, tagging, or coding of information for retrieval purposes. In some cases, the tagging or coding is automatically executed by the data cloud server 105. In addition, the data cloud server 105 allows a user (e.g., user of the secure computing environment 125) to transition from accessing structured data from the local repository 130 to the data cloud server 105.

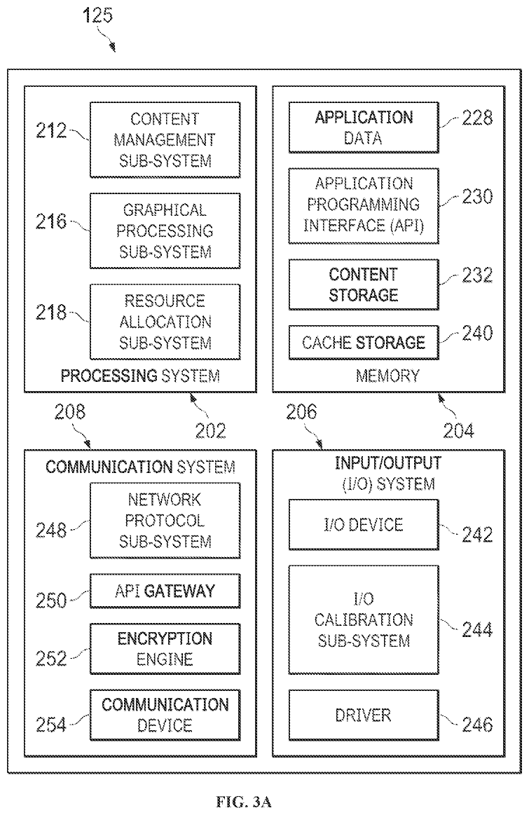

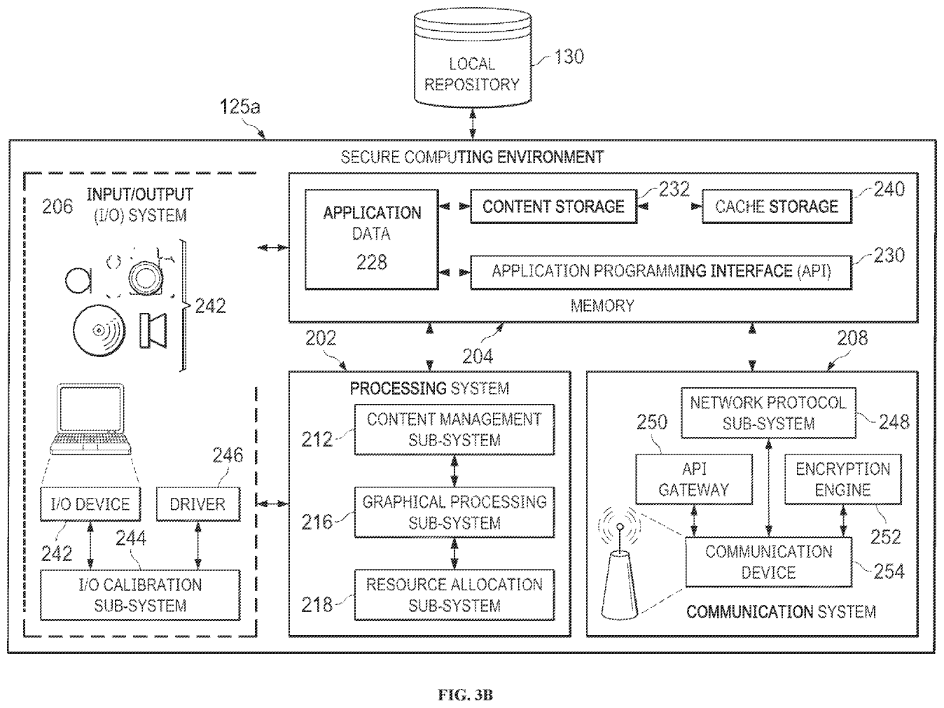

The data cloud server 105 may be implemented within a computing device such as a mainframe server, a content server, a communication server, a laptop computer, a desktop computer, a handheld computing device, a virtual machine, a cloud-based computing solution and/or service, and/or the like. The data cloud server 105 may include a plurality of computing devices configured to communicate with one another and/or implement the techniques described herein. In some instances, the data cloud server 105 may include various elements of a computing environment as described with reference to FIGS. 3A and/or 3B. For example, the data cloud server 105 may include a processing system 202, a memory 204, an input/output (I/O) system 206, and a communication system 208. A user (e.g., database administrator) may operate/maintain the data cloud server 105 either locally or remotely as the case may require.

The data cloud server 105 may be configured to have storage logic that is executable to store structured data that is shared across multiple secure computing environments 125. According to one implementation, the data cloud server 105 may include a plurality of non-volatile/non-transitory storage media such as solid state storage media, hard disk storage media, virtual storage media, cloud-based storage drives, storage servers, and/or the like. The plurality of storage media may be configured to store data from a plurality of sources. For example, the data cloud server 105 may include storage logic that is executable to store structured data derived from, for example, medical data, research data, education data, government data, etc. According to some implementations, the storage logic of the data cloud server 105 may be configured to automatically monitor and/or update relevant structured data obtained from a third-party source. For example, the storage logic of the data cloud server 105 may periodically monitor updates associated with structured data (e.g., dictionary of medical terms for research and regulatory purposes) from third-party organizations/sources and automatically update different versions of the structured data within one or more storage media of the data cloud server 105. In one embodiment, the storage logic of the data cloud server 105 manipulates or otherwise formats the structured data such that user interfaces generated by a secure computing environment 125 can seamlessly access/retrieve and present the structured data to a user. In addition, structured data from the data cloud server 105 may be accessed on a regulated basis via credential access, for example. This regulated basis may be determined, in part, by licenses, privileges, and other levels of authorization dictated by a user's credentials.

The external source 112 may operate similarly like the data cloud server 105 including having all the technical features of the data cloud server 105 described herein. The difference between the external source 112 and the data cloud server 105 is the external source 112 operates in providing information to the data cloud server 105 when requested. While a single external source 112 is illustrated, the disclosed principles and techniques could be expanded to include multiple external sources 112.

The local repository 130 may include storage logic for storing a local copy of structured data from the data cloud server 105. The local repository 130 may also be configured to store data other than the structured data. For example, the local repository 130 may store data from third-party sources and other data generated by the secure computing environment 125. The local repository may include a plurality of non-volatile/non-transitory storage media such as solid state storage media, hard disk storage media, virtual storage media, cloud-based storage drives, storage servers, and/or the like. According to some embodiments, the local repository 130 may include logic that updates structured data stored within its storage devices based on updates to structured data stored within the data cloud server 105. In some cases, snapshots of structured data may be accessed using the secure computing environment 125 so that updates associated with the snapshots may be effected on the local repository 130.

As previously discussed, the network 110 facilitates communication between the data cloud server 105, the external source 112, and the secure computing environment 125. The network 110 may also allow different secure computing environments 125 to communicate with each other. According to one embodiment, the network 110 may include a plurality of networks. For instance, the network 110 may include any wired/wireless communication network that facilitates communication between the components of the network system 100. The network 110, in some instances, may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a fiber optics network, a laser-based network, and/or the like.

The secure computing environment 125 is configured to generate one or more user interfaces for accessing, analyzing, and displaying the structured data. According to some implementations, the secure computing environment 125 includes functionalities and/or enhanced security features that allow a user to securely access and/or securely manage structured data. As shown more clearly in the exemplary functional and system diagrams of FIGS. 3A and 3B, the secure computing environment 125 includes a processing system 202, a memory 204, and I/O system 206, and a communication system 208. The processing system 202, the memory 204, the I/O system 206, and the communication system 208 may include one or more subsystems that perform one or more of the operations described herein. Additionally, each system of the secure computing environment 125 may be operatively and/or otherwise communicatively coupled with each other so as to facilitate one or more operations described herein. The secure computing environment 125 may include general hardware, specifically-purposed hardware, and/or a combination thereof.

The processing system 202 may control the memory 204, the I/O system 206, and the communication system 208, as well as any included subsystems, elements, components, devices, and/or functions performed by the memory 204, I/O system 206, and the communication system 208. Additionally, any actions described in this disclosure as being performed by a processor or one or more processors of a computing device or one or more computing device processors and/or one or more computing system processors may be executed by the processing system 202 of FIGS. 3a and 3b. Further, while one processing system 202 is shown in FIGS. 3A and 3B, multiple processing systems may be present and/or otherwise included in the secure computing environment 125 or elsewhere in the overall network system 100 of FIG. 1. Thus, while instructions may be described as being executed by the processing system 202 (and/or various subsystems of the processing system 202), the instructions may be executed simultaneously, serially, and/or otherwise by one or multiple processing systems 202 on one or more computing devices.

According to one embodiment, the processing system 202 may be implemented as one or more computer processor chips and/or graphical processing unit (GPU) chips and may include a hardware device capable of executing computer instructions. The processing system 202 may execute instructions, codes, computer programs, and/or scripts. The instructions, codes, computer programs, and/or scripts may be received from the I/O system 206, the communication system 208, and/or stored in the memory 204, and/or received from the other subsystems of the secure computing environment 125 and/or received from other computing environments.

In some embodiments, the processing system 202 may include subsystems such as a content management subsystem 212, a graphical processing subsystem 216, and a resource allocation subsystem 218. Each of the aforementioned subsystems of the processing system 202 may be communicatively or operably coupled to each other.

The content management sub-system 212 may facilitate generation, modification, analysis, transmission, and/or presentation of content. Content may be file content, media content, structured data content, user interfaces, or any combination thereof. In some instances, content on which the content management system 212 operates includes structured data from the data cloud server 105, structured data from the local repository 130, user interface data, device information, images, text, themes, audio files, video files, documents, and/or the like. Additionally, the content management subsystem 212 may control the audio-visual environment and/or appearance of application data during execution of various processes. In some embodiments, the content management subsystem 212 may interface with a third-party content server and/or third-party memory locations for execution of its operations.

The graphical processing subsystem 216 may facilitate generation, modification, analysis, processing, transmission, and/or presentation of the content described above, as well as any data described herein. In some embodiments, the graphical processing subsystem 216 may be used to render content for presentation on a computing device (e.g., via a graphical user interface of the computing device). The graphical processing subsystem 216 may also include multiple graphical processing subsystems and therefore may be configured to perform and/or execute multiple processes in parallel. In some implementations, the graphical processing subsystem 216 may be used in conjunction with components of the memory 204, the I/O system 206, the communication system 208, and/or a combination thereof.

The resource allocation subsystem 218 may facilitate the determination, monitoring, analysis, and/or allocation of computing resources throughout the secure computing environment 125 and/or other computing environments. Computing resources of the secure computing environment 125 may be used by the processing system 202, the memory 204, the I/O system 206, and/or the communication system 208. These resources may include processing power, data storage space, network bandwidth, and/or the like. Accordingly, the resource allocation subsystem 218 may include sensors and/or other specially-purposed hardware for monitoring performance of each system and/or subsystem of the secure computing environment 125, as well as hardware for responding to the computing-resource needs of each system and/or subsystem. In some embodiments, the resource allocation subsystem 218 may use computing resources of a second secure computing environment separate and distinct from the secure computing environment 125 to facilitate a desired operation.

The memory 204 may be used for storing, recalling, receiving, transmitting, and/or accessing various files and/or data (e.g., structured data) during the operation of the secure computing environment 125. For example, the memory 204 may store, recall, and/or update structured data from the data cloud and/or the local repository as the case may be. In some embodiments, the memory 204 may store instructions and/or data that may be executed by the processing system 202. For instance, the memory 204 may store instructions that execute operations associated with one or more systems and/or one or more subsystems of the secure computing environment 125. For example, the memory 204 may store instructions for the processing system 202, the I/O system 206, the communication system 208, and for itself.

Memory 204 may include various types of data storage media such as solid state storage media, hard disk storage media, virtual storage media, and/or the like. Memory 204 may include dedicated hardware elements such as hard drives and/or servers, as well as software elements such as cloud-based storage drives. In some implementations, memory 204 may be a random access memory (RAM) device, a dynamic random access memory (DRAM) device, a static random access memory (SRAM) device, flash memory, read only memory (ROM) device, and/or various forms of secondary storage. The RAM device may be used to store volatile data and/or to store instructions that may be executed by the processing system 202. For example, the instructions stored may be a command, a current operating state of secure computing environment 125, an intended operating state of secure computing environment 125, and/or the like. As a further example, data stored in the memory 204 may include instructions related to various methods and/or functionalities described herein. The ROM device may be a non-volatile memory device that may have a smaller memory capacity than the memory capacity of a secondary storage of the secure computing environment. The ROM device may be used to store instructions and/or data that may be read during execution of computer instructions. In some embodiments, access to both the RAM device and ROM device may be faster to access than access to the secondary storage of the secure computing environment 125. Secondary storage may comprise one or more disk drives and/or tape drives which may be used for non-volatile/non-transitory storage of data or as an over-flow data storage device of the secure computing environment 125 if the RAM device is not large enough to hold all working data. Secondary storage may be used to store programs that may be loaded into the RAM device when such programs are selected for execution.

Turning back to FIG. 3A, the memory 204 may include subsystems such as application data 228, application programming interface 230, content storage 232, and cache storage 240. Application data 228 may facilitate deployment, storage, access, execution, and/or utilization of an application utilized by the secure computing environment 125 and/or any other computing environments described herein. As such, application data 228 may store any information and/or data associated with an application. Application data 228 may further store various pieces of information and/or data associated with the operation of an application and/or with the secure computing environment 125 as a whole, such as a status of computing resources (e.g., processing power, memory availability, resource utilization, and/or the like), runtime information, user interfaces, systems to direct execution of operations described herein to, user permissions, security credentials, and/or the like.

The application programming interface (API) 230 may facilitate deployment, storage, access, execution, and/or utilization of information associated with APIs of secure computing environment 125 and/or any other computing environment described herein. For example, secure computing environment 125 may include one or more APIs for various devices, applications, systems, subsystems, elements, and/or other computing environments to allow communication between one or more applications associated with the secure computing environment 125. Accordingly, API 230 may include API databases containing information that may be accessed and/or used by applications, systems, subsystems, elements, and/or operating systems of other devices and/or computing environments in communication with the secure computing environment 125. In some cases, the API 230 may enable the data cloud server 105 and the secure computing environment 125 to communicate with each other.

The content storage 232 may facilitate deployment, storage, access, and/or utilization of information associated with structured data as further discussed below. In one embodiment, content storage 232 may communicate with a content management system 212 to receive and/or transmit content (e.g., structured data, media content, etc.).

The I/O system 206 may include hardware and/or software elements for the secure computing environment 125 to receive, and/or transmit, and/or present information useful for generating one or more interfaces for retrieving and displaying structured data according to some embodiments of this disclosure. For example, elements of the I/O system 206 may be used to receive input from a user of the secure computing environment 125. As described herein, I/O system 206 may include subsystems such as I/O device 242, I/O calibration subsystem 244, and/or driver 246.

The I/O device 242 may facilitate the receipt, transmission, processing, presentation, display, input, and/or output of information as a result of executed processes described herein. In some embodiments, the I/O device 242 may include a plurality of I/O devices. In some embodiments, I/O device 242 may include a variety of elements that enable a user to interface with secure computing environment 125. For example, I/O device 242 may include a keyboard, a touchscreen, a button, a sensor, a biometric scanner, a laser, a microphone, a camera, and/or another element for receiving and/or collecting input from a user. Additionally and/or alternatively, I/O device 242 may include a display, a screen, a sensor, a vibration mechanism, a light emitting diode (LED), a speaker, a radio frequency identification (RFID) scanner, and/or another element for presenting and/or otherwise outputting data to a user. In some embodiments, the I/O device 242 may communicate with one or more elements of processing system 202 and/or memory 204 to execute operations associated with generating user interfaces for retrieving and visualizing structured data.

The I/O calibration system 244 may facilitate the calibration of the I/O device 242. For example, I/O calibration system 244 may detect and/or determine one or more settings of I/O device 242, and then adjust and/or modify settings so that the I/O device 242 may operate more efficiently. In some embodiments, I/O calibration system 244 may use a driver 246 (or multiple drivers) to calibrate I/O device 242 as needed. For example, driver 246 may include software that is to be installed by I/O calibration system 244 so that an element of secure computing environment 125 (or an element of another computing environment) may recognize and/or integrate with I/O device 242.

The communication system 208 may facilitate establishment, maintenance, monitoring, and/or termination of communications between the secure computing environment 125 and other computing environments, third-party server systems, and/or the like. Communication system 208 may also facilitate internal communications between various elements (e.g., systems and/or subsystems) of secure computing environment 125. In some embodiments, communication system 208 may include a network protocol subsystem 248, an API gateway 250, an encryption engine 252, and/or a communication device 254. These systems and/or subsystems of the communication system 208 may be implemented as hardware, software, or a combination thereof.

The network protocol subsystem 248 may facilitate establishment, maintenance, and/or termination of a communication connection for the secure computing environment 125 via a network (e.g., network 110). For example, network protocol subsystem 248 may detect and/or define a communication protocol required by a particular network and/or network type. Communication protocols utilized by network protocol subsystem 248 may include Wi-Fi protocols, Li-Fi protocols, cellular data network protocols, Bluetooth® protocols, internet protocols, WiMAX protocols, Ethernet protocols, power line communication (PLC) protocols, and/or the like. In some embodiments, facilitation of communication for the secure computing environment 125 may include transforming and/or translating data from a first communication protocol to a second communication protocol. In some embodiments, network protocol subsystem 248 may determine and/or monitor an amount of data traffic to determine which network protocol is to be used for establishing a secure communication connection, transmitting data, and/or performing retrieval and subsequent visualization of structured data.

The application programming interface (API) gateway 250 may allow other devices and/or computing environments and/or applications external to the secure computing environment 125 to access the API 230 of the memory 204. For example, a computing system may access the API 230 of the secure computing environment 125 via the API gateway 250. In some embodiments, API gateway 250 may be required to validate user credentials associated with a user of a computing device (e.g., a device external to the secure computing environment 125) prior to providing access to the API 230 to the user. API gateway 250 may include instructions for the secure computing environment 125 and thereby communicate with external devices and/or between components of the secure computing environment 125.

The encryption engine 252 may facilitate translation, encryption, encoding, decryption, and/or decoding of information received, transmitted, and/or stored by the secure computing environment 125. Using encryption engine 252, each transmission of data may be encrypted, encoded, and/or translated for security reasons, and any received data may be encrypted, encoded, and/or translated prior to its processing and/or storage. In some embodiments, encryption engine 252 may generate an encryption key, an encoding key, a translation key, and/or the like, which may be transmitted along with any data content.

The communication device 254 may include a variety of hardware and/or software specifically purposed to facilitate communication for secure computing environment 125 with external systems and/or devices. In some embodiments, communication device 254 may include one or more radio transceivers, chips, analog front end (AFE) units, antennas, processing units, memory, other logic, and/or other components to implement communication protocols (wired or wireless) and related functionality for facilitating communication for system 125. Additionally and/or alternatively, communication device 254 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

In some embodiments, the invention includes an apparatus for aggregation of disparate data received from disparate data systems in a complex computing network for establishing a virtual computation and control system associated with and utilizing the aggregated disparate data, the aggregation, processing, and generating of visual representations necessarily rooted in computing technology, the apparatus comprising: a hardware data communication interface for: establishing a first connection to a first input data system, the first input data system being associated with a first set of geographical data, the first set of geographical data being based on a first location; receiving the first set of geographical data on the first connection; establishing a second connection to a second input data system, the second input data system being associated with a second set of geographical data, the second set of geographical data being based on a second location; receiving the second set of geographical data on the second connection; receiving first identifying information for the first location and second identifying information; a hardware digital data processor for: analyzing the first set of geographical data and the second set of geographical data; charting the first location and the second location based on the first identifying information and the second identifying information to create a first location identifier and a second location identifier; aggregating the first set of geographical data and the second set of geographical data to create an aggregate set of data; sorting the aggregate data into the first location identifier and the second identifier; and a hardware user interface, wherein: a first user accesses the hardware user interface; the hardware user interface receives the sorted aggregate data, the first location identifier, and the second location identifier, the first user accesses sorted aggregate data, wherein the first user is able to view if the sorted aggregate data is sorted into the first location identifier or the second location identifier; the hardware user interface generates a virtual representation of the first location or the second location; and adjusting the virtual representation of the first location or the second location based on an action from the first user.

In some embodiments, the invention includes an apparatus for aggregation of disparate data received from disparate data systems in a complex computing network for establishing a virtual computation and control system associated with and utilizing the aggregated disparate data, the aggregation, processing, and generating of digital platforms necessarily rooted in computing technology, the digital platforms serving as interaction points for a user, the apparatus comprising: a hardware data communication interface for: establishing a first connection to a first input data system, the first input data system being associated with a first set of geographical data, the first set of geographical data being based on a first location; receiving the first set of geographical data on the first connection; establishing a second connection to a second input data system, the second input data system being associated with a second set of geographical data, the second set of geographical data being based on a second location; receiving the second set of geographical data on the second connection; receiving first identifying information for the first location and second identifying information for the second location; a hardware digital data processor for: analyzing the first set of geographical data and the second set of geographical data; charting the first location and the second location based on the first identifying information and the second identifying information to create a first location identifier and a second location identifier; aggregating the first set of geographical data and the second set of geographical data to create an aggregate set of data; sorting the aggregate data into the first location identifier and the second identifier; and a hardware user interface, wherein: a first user accesses the hardware user interface; the hardware user interface receives the sorted aggregate data, the first location identifier, and the second location identifier, the first user accesses sorted aggregate data, wherein the first user is able to view if the sorted aggregate data is sorted into the first location identifier or the second location identifier; the hardware user interface generates a digital platform linked to the first location identifier or the second location identifier, wherein the digital platform displays a variety of icons related to the first location or the second location; and receiving an input from the first user, wherein the first user supplements the sorted aggregate data; adjusting the sorted aggregate data based on the input; and regenerating the variety of icons based on the adjustment of the sorted aggregate data.

In some embodiments, an apparatus may be provided for virtual computation and control of assets by aggregating data provided by a plurality of data input systems. The aggregation of data being rooted in computing technology. The apparatus comprises: an aggregation network system for: establishing a first connection to a first data input system; receiving, from the first data input system, a first asset data set; establishing a second connection to a second data input system; receiving, from the second data input system, a second asset data set; establishing a third connection to a third data input system; receiving, from the third data input system, a third asset data set; aggregating the first asset data set, second asset data set, and third asset data set; and generating an aggregate data set; a virtual computation and control system for: receiving the aggregate data set; sorting the aggregate data set; generating a first aggregate location data from the sorted aggregate data set; and generating a virtual representation of the first aggregate location data; a first user interface for: accessing the first aggregate location data; and controlling the first aggregate location data; and a second user interface for: viewing the first aggregate location data.

In some embodiments, the aggregation network system comprises a logic unit for executing computing operations on input data received from data input systems, and a control unit for informing the logic unit which computing operations are to be executed on the input data received from input data systems, wherein the logic unit in coordination with the control unit is further for executing or performing various operations of the aggregation network system. In some embodiments, the aggregation network system may perform operations such as accessing asset data sets, establishing connections with disparate data input systems, processing disparate data sets, aggregating disparate data sets, etc. Further, in some embodiments, the aggregation network system can be operated by a single controlling user.

In some embodiments, the plurality of data input systems are associated with assets, wherein the assets may be virtual property, electronic property, personal property, or real property such as single-family homes, semi-detached homes, multi-family homes, townhomes, apartments, or condominiums.

In some embodiments, the first data input system further comprises a first data input system communication interface for providing the first asset data set, wherein the first data input system communication interface is connected to a first data input system repository for storing the first asset data set, wherein the first data input system repository is connected to a first data input system processor, wherein the first data input system processor collects data associated with the first data input system and aggregates the data into the first asset data set.

In some embodiments, the first asset data set is associated with a unique distinct address, wherein the unique distinct address identifies the first data input system, wherein the first data input system is associated with a first asset, wherein the first asset may be virtual property, electronic property, personal property, or real property such as single-family homes, semi-detached homes, multi-family homes, townhomes, apartments, or condominiums. Further, the first asset data may comprise safety data associated with the unique distinct address, wherein the safety data may include local crime data, incident data, construction data, weather data, etc. The first asset data may further comprise asset specification data associated with the asset identified by the unique distinct address, wherein the asset specification data may include compliance data, construction data, structural data, occupancy data, financial data, maintenance data, etc.

In some embodiments, the second data input system further comprises a second data input system communication interface for providing the second asset data set, wherein the second data input communication interface is connected to a second data input system repository for storing the second asset data set, wherein the second data input system repository is connected to a second data input system processor, wherein the second data input system processor collects data associated with the second data input system and aggregates the data into the second asset data set.

In some embodiments, the second asset data set is associated with a unique distinct address, wherein the unique distinct address identifies the second data input system, wherein the second data input system is associated with a second asset wherein the second asset may be a virtual property, electronic property, personal property, or real property such as single-family homes, semi-detached homes, multi-family homes, townhomes, apartments, or condominiums. Further, the second asset data may comprise safety data associated with the unique distinct address, wherein the safety data may include local crime data, incident data, construction data, weather data, etc. The second asset data may further comprise asset specification data associated with the asset identified by the unique distinct address, wherein the asset specification data may include compliance data, construction data, structural data, occupancy data, financial data, maintenance data, etc.

In some embodiments, the virtual computation and control system comprises a logic unit for executing computing operations on input data received from input data systems, and a control unit for informing the logic unit which computing operations are to be executed on the input data received from input data systems, wherein the logic unit in coordination with the control unit is further for executing or performing various operations of the virtual computation and control system. In some embodiments, the virtual computation and control system may perform operations such as accessing aggregate data sets, sorting aggregate data sets by organizing data based on location data, generating disparate aggregate location data based on the sorted aggregate data, and generating a virtual representation of assets based on each aggregate location data. Aggregate location data may comprise: safety data such as crime data, incident data, construction data, weather data, etc.; asset specification data such as compliance data, construction data, structural data, occupancy data, financial data, maintenance data, etc.; and social data such as occupant data, demographic data, educational data, employment data, etc. The virtual computation and control system may further perform operations such as processing reservations of administrative services, processing reservations for financial services, processing financial data computations, computing asset specification data, processing asset specification control requests, creating network communications, processing asset maintenance requests. Further, in some embodiments, the aggregation network system can be operated by a single controlling user.

In some embodiments, the virtual computation and control system is further configured to moderate network communications between multiple users, wherein the virtual computation and control system is further connected to a user communications platform, wherein the user communications platform is for: establishing a first user communication connection to a first communications platform user; receiving, from the first communications platform user, a first communications platform message; establishing a second user communication connection to a second communications platform user; providing the first communications platform message to the second communications platform user; receiving, from the second communications platform user, a second communications platform message; and providing the second communications platform message to the first communications platform user. In some embodiments, when a user utilizes the user communications platform, the user communications platform may send one or more messages to the virtual computation and control system, wherein the one or more messages may be for reservations of administrative services, reservations for financial services, financial data computations, asset specification data computations, asset specification control requests, network communications, asset maintenance requests, local institution network communications, etc.

In some embodiments the user communications platform is for: establishing a first user communication connection to a first communications platform user; receiving, from the first communications platform user, a first communications platform message; establishing, simultaneously, a second user communication connection to a second communications platform user and a third user communication connection to a third communications platform user; providing, simultaneously, the first communications platform message to the second communications platform user and the third user communications platform user; receiving, simultaneously, from the second communications platform user, a second communications platform message and, from the third communications platform user, a third communications platform message; and providing, simultaneously, the second communications platform message and the third communications platform message to the first communications platform user. In some embodiments, when a user utilizes the user communications platform, the user communications platform may send one or more messages to the virtual computation and control system, wherein the one or more messages may be for reservations of administrative services, reservations for financial services, financial data computations, asset specification data computations, asset specification control requests, network communications, asset maintenance requests, local institution network communications, etc.

In some embodiments, the first communications platform user is a controller user, wherein the controller user can access the first aggregate location data using the first user interface.

In some embodiments, the controller user may use the first user interface to control the first aggregate location data for generating content, wherein content may be file content, media content, user content, application content, operating system content, etc., or any combination thereof. In some embodiments, content may include asset specification data, user interface data, image data, text data, theme data, audio data, video data, documents, etc. The controller user may further control the virtual representation of the first aggregate location data by incorporating content into the virtual representation.

In some embodiments, when a user utilizes the second user interface to establish a connection with the virtual computation and control system, the user may view the virtual representation of the first aggregate location data. The user may further use the second user interface to utilize the user communications platform, wherein the user may utilize the user communications platform to interact with the controller user. The user may further utilize the second user interface and the user communications platform to interact with other users. The user for the second user interface may be a user occupying an asset, a user associated with a local business institution, a user processing asset maintenance requests, a user processing financial data computation requests, a user processing administrative service requests. The user may also use the second user interface to promote events, gatherings, conferences, activities, etc.

In some embodiments, the virtual computation and control system is further for asset computation and control, wherein asset computation and control comprises: receiving the first aggregate location data from the aggregation network system; displaying the first aggregate location data; providing the controller user with options for, including but not limited to: generating asset computation and control information; creating asset computation and control communications; analyzing asset computation and control status; receiving user communications platform data; analyzing user communications platform data. In some embodiments, the controller user may use the first user interface to operate the virtual computation control system. The controller user may further use the first user interface to control the display of the first aggregate location data, wherein the display of the first aggregate location data may be the virtual representation of the first aggregate location data. The display of the first aggregate location data may further be a visual representation, audio representation, textual representation, etc. The controller user may further operate the generation of asset computation and control information by using the first user interface to select the data and generation method used to generate the asset computation and control information. The controller user may further operate the analysis of asset computation and control status by using the first user interface to select the factors used for the analysis. The controller user may also operate the analysis of the user communications platform data by using the first user interface to select the factors used for the analysis. In some embodiments, asset computation and control information comprises the first aggregate location data, wherein the first aggregate location data further comprises user communication identifier information, asset valuation data, asset computation and control organization valuation data, asset condition information, asset environment data.

In some embodiments, the virtual computation and control system is further connected to a virtual network communications platform, wherein the virtual network communications platform is for: establishing a first user communication connection to a first virtual network communications user; receiving, from the first communications user, a first virtual network communications user data; generating a virtual representation of the first virtual network communications user; establishing a second user communication connection to a second virtual network communications platform user; receiving, from the second virtual network communications user, a second virtual network communications user data; generating a virtual representation of the second virtual network communications user; receiving, from the first virtual network communications user, a first virtual network communications message; generating a virtual representation of the first virtual network communications message; providing the virtual representation of the first virtual network communications message to the second virtual network communications user; receiving, from the second virtual network communications user, a second virtual network communications message; generating a virtual representation of the second virtual network communications message; and providing the virtual representation of the second virtual network communications message to the first virtual network communications user. In some embodiments, when a user utilizes the virtual network communications platform, the virtual network communications platform may send one or more messages to the virtual computation and control system, wherein the one or more messages may be for reservations of administrative services, reservations for financial services, financial data computations, asset specification data computations, asset specification control requests, network communications, asset maintenance requests, local institution network communications, etc.

In some embodiments the virtual network communications platform is for: establishing a first user communication connection to a first virtual network communications user; receiving, from the first communications user, a first virtual network communications user data; generating a virtual representation of the first virtual network communications user; establishing a second user communication connection to a second virtual network communications platform user; receiving, from the second virtual network communications user, a second virtual network communications user data; generating a virtual representation of the second virtual network communications user; establishing a third user communication connection to a third virtual network communications platform user; receiving, from the third virtual network communications user, a third virtual network communications user data; generating a virtual representation of the third virtual network communications user; receiving, from the first virtual network communications user, a first virtual network communications message; generating a virtual representation of the first virtual network communications message; providing the virtual representation of the first virtual network communications message to the second virtual network communications user and the third virtual network communications user simultaneously; receiving, from the second virtual network communications user, a second virtual network communications message; generating a virtual representation of the second virtual network communications message; and providing the virtual representation of the second virtual network communications message to the first virtual network communications user and the third virtual network communications user simultaneously. In some embodiments, when a user utilizes the virtual network communications platform, the virtual network communications platform may send one or more messages to the virtual computation and control system, wherein the one or more messages may be for reservations of administrative services, reservations for financial services, financial data computations, asset specification data computations, asset specification control requests, network communications, asset maintenance requests, local institution network communications, etc.

In some embodiments, the first virtual network communications user is a controller user, wherein the controller user can access the set of asset computation and control information, wherein the virtual network communications platform further generates a virtual representation of the asset computation and control information. In some embodiments, the controller user may use the first user interface to operate the virtual computation control system. The controller user may further use the first user interface to control the display of the first aggregate location data, wherein the display of the first aggregate location data may be the virtual representation of the first aggregate location data. The display of the first aggregate location data may further be a visual representation, audio representation, textual representation, etc. The controller user may further operate the generation of asset computation and control information by using the first user interface to select the data and generation method used to generate the asset computation and control information. The controller user may further operate the analysis of asset computation and control status by using the first user interface to select the factors used for the analysis. The controller user may also operate the analysis of the user communications platform data by using the first user interface to select the factors used for the analysis.

In some embodiments, when a user utilizes the second user interface to establish a connection with the virtual computation and control system, the user may view the virtual representation of the first aggregate location data. The user may further use the second user interface to utilize the user communications platform, wherein the user may utilize the user communications platform to interact with the controller user. The user may further utilize the second user interface and the user communications platform to interact with other users. The user for the second user interface may be a user occupying an asset, a user associated with a local business institution, a user processing asset maintenance requests, a user processing financial data computation requests, a user processing administrative service requests. The user may also use the second user interface to promote events, gatherings, conferences, activities, etc.

In some embodiments, asset computation and control information comprises the first aggregate location data, wherein the first aggregate location data further comprises user communication identifier information, asset valuation data, asset computation and control organization valuation data, asset, specification, asset condition information, asset environment data.

In some embodiments, a method for virtual computation and control of assets by aggregating data provided by a plurality of data input systems is provided. The aggregation of data being rooted in computing technology. The method comprises establishing a first connection from an aggregation network system to a first data input system; receiving, from the first data input system, a first asset data set; establishing a second connection to a second data input system; receiving, from the second data input system, a second asset data set; establishing a third connection to a third data input system; receiving, from the third data input system, a third asset data set; aggregating the first asset data set, second asset data set, and third asset data set; generating an aggregate data set; from the aggregate network system, a virtual computation and control system receiving the aggregate data set; the virtual computation and control system sorting the aggregate data set; the virtual computation and control system generating a first aggregate location data from the sorted aggregate data set; the virtual computation and control system generating a virtual representation of the first aggregate location data; a first user interface accessing the first aggregate location data; the first user interface controlling the first aggregate location data; and a second user interface viewing the first aggregate location data.

In some embodiments, another apparatus provides a virtual computation and control system for controlling assets by aggregating disparate data received from disparate data systems in a complex computing network. The virtual computation and control system may be used by an asset computation and control organization for controlling asset information and network communications. The virtual computation and control system may be rooted in computing technology. The apparatus comprises: a hardware data communication interface for: establishing a first connection to a first input data system, the first input data system being associated with a first set of geographical data, the first set of geographical data being based on a first location; receiving the first set of geographical data on the first connection; establishing a second connection to a second input signal system, the second input data system being associated with a second set of geographical data, the second set of geographical data being based on a second location; receiving the second set of geographical data on the second connection; receiving identifying information for the first location and for the second location; a hardware digital processor for: analyzing the first set of geographical data and the second set of geographical data; charting the first location and the second location based on the identifying information to create a first location identifier and a second location identifier; aggregating the first set of geographical data and the second set of geographical data to create an aggregate set of data; sorting the aggregate data into the first location identifier and the second location identifier; and a hardware user interface, wherein: a first user accesses the hardware user interface; the hardware user interface receives the sorted aggregate data, the first location identifier, and the second location identifier; the first user accesses sorted aggregate data, wherein the first user is able to view if the sorted aggregate data is sorted into the first location identifier or the second location identifier; and the hardware user interface generates a virtual representation of the first location or the second location.

In some embodiments, the hardware data communication interface comprises a logic unit for executing computing operations on disparate data received from disparate data systems, and a control unit for informing the logic unit which computing operations are to be executed on the disparate data received from disparate data systems, wherein the logic unit in coordination with the control unit is further for executing or performing various operations of the hardware data communication interface.

In some embodiments, the first input data system further comprises a first input data system communication interface for providing the first set of geographical data, wherein the first input data communication interface is connected to a first input data system repository for storing the first set of geographical data, wherein the first input data system repository is connected to a first input data system processor, wherein the first input data system processor collects data associated with the first input data system and aggregates the data into the first set of geographical data.

In some embodiments, the first set of geographical data being based on a first location is associated with a unique distinct address, wherein the unique distinct address identifies the first input data system, wherein the first input data system is associated with a first asset, wherein the first asset may be virtual property, electronic property, personal property, or real property.

In some embodiments, the second input data system further comprises a second input data system communication interface for providing the second set of geographical data, wherein the second input data communication interface is connected to a second input data system repository for storing the second set of geographical data, wherein the second input data system repository is connected to a second input data system processor, wherein the second input data system processor collects data associated with the second input data system and aggregates the data into the second set of geographical data.

In some embodiments, the second set of geographical data being based on a second location is associated with a unique distinct address, wherein the unique distinct address identifies the second input data system, wherein the second input data system is associated with a second asset wherein the second asset is at least one of a virtual property, electronic property, personal property, real property such as single-family homes, semi-detached homes, multi-family homes, townhomes, apartments, or condominiums.

In some embodiments, the first connection is further for a first input communication, wherein the first input communication comprises the first set of geographical data being based on the first location.

In some embodiments, the second communication is further for a second input communication, wherein the second input communication comprises the second set of geographical data being based on the second location.

In some embodiments, the first input communication or the second input communication comprises multiple communications or transmissions or a single communication or transmission.

In some embodiments, the first input communication is associated with a first user.

In some embodiments, the first input communication further comprises a first input signal, wherein the first input signal is accessible by the hardware data communication interface.

In some embodiments, the second input communication further comprises a second input signal, wherein the second input signal is accessible by the hardware data communication interface.

In some embodiments, the hardware digital processor is further for: processing multiple communications received from disparate data systems in a complex computing network; moderating multiple communications between disparate data systems; and creating network communications to be accessible by disparate data systems.

In some embodiments, creating network communications to be accessible by disparate data systems permits disparate data systems to directly communicate with one another.

In some embodiments, creating network communications to be accessible by disparate data systems permits separate disparate data systems to directly communicate with one another.

In some embodiments, creating network communications to be accessible by disparate data systems permits numerous disparate data systems to directly communicate with one another.

In some embodiments, the sorted aggregate data is a set of asset computation and control information.

In some embodiments, charting may be association of information with a specific location.

In some embodiments, charting may be visually mapping information based on geographical representations.

In some embodiments, sorting may be organizing information based on geographical data.

In some embodiments, the hardware user interface is further for creating networking communications between multiple users, wherein the hardware use interface is further connected to a user communications platform, wherein the user communications platform is for: establishing a first user communication connection to a first communications platform user; receiving, from the first communications platform user, a first communications platform message; establishing a second user communication connection to a second communications platform user; providing the first communications platform message to the second communications platform user; receiving, from the second communications platform user, a second communications platform message; and providing the second communications platform message to the first communications platform user.

In some embodiments the user communications platform is for: establishing a first user communication connection to a first communications platform user; receiving, from the first communications platform user, a first communications platform message; establishing, simultaneously, a second user communication connection to a second communications platform user and a third user communication connection to a third communications platform user; providing, simultaneously, the first communications platform message to the second communications platform user and the third user communications platform user; receiving, simultaneously, from the second communications platform user, a second communications platform message and, from the third communications platform user, a third communications platform message; and providing, simultaneously, the second communications platform message and the third communications platform message to the first communications platform user.

In some embodiments, the first communications platform user is a controller user, wherein the controller user can access the set of asset computation and control information.

In some embodiments, a communications platform message may be a service request.

In some embodiments, the hardware user interface is further for asset computation and control, wherein asset computation and control comprises: receiving the sorted aggregate data from the hardware digital data processor; displaying the sorted aggregate data; providing the controller user with options for, including but not limited to: generating asset computation and control information; creating asset computation and control communications; analyzing asset computation and control status; receiving user communications platform data; analyzing user communications platform data.

In some embodiments, asset computation and control information comprises the sorted aggregate data, wherein the sorted aggregate data further comprises user communication identifier information, asset valuation data, asset computation and control organization valuation data, asset specification, asset condition information, asset environment data.

In some embodiments, the hardware user interface is further connected to a virtual network communications platform, wherein the virtual network communications platform is for: establishing a first user communication connection to a first virtual network communications user; receiving, from the first communications user, a first virtual network communications user data; generating a virtual representation of the first virtual network communications user; establishing a second user communication connection to a second virtual network communications platform user; receiving, from the second virtual network communications user, a second virtual network communications user data; generating a virtual representation of the second virtual network communications user; receiving, from the first virtual network communications user, a first virtual network communications message; generating a virtual representation of the first virtual network communications message; providing the virtual representation of the first virtual network communications message to the second virtual network communications user; receiving, from the second virtual network communications user, a second virtual network communications message; generating a virtual representation of the second virtual network communications message; and providing the virtual representation of the second virtual network communications message to the first virtual network communications user.

In some embodiments the virtual network communications platform is for: establishing a first user communication connection to a first virtual network communications user; receiving, from the first communications user, a first virtual network communications user data; generating a virtual representation of the first virtual network communications user; establishing a second user communication connection to a second virtual network communications platform user; receiving, from the second virtual network communications user, a second virtual network communications user data; generating a virtual representation of the second virtual network communications user; establishing a third user communication connection to a third virtual network communications platform user; receiving, from the third virtual network communications user, a third virtual network communications user data; generating a virtual representation of the third virtual network communications user; receiving, from the first virtual network communications user, a first virtual network communications message; generating a virtual representation of the first virtual network communications message; providing the virtual representation of the first virtual network communications message to the second virtual network communications user and the third virtual network communications user simultaneously; receiving, from the second virtual network communications user, a second virtual network communications message; generating a virtual representation of the second virtual network communications message; and providing the virtual representation of the second virtual network communications message to the first virtual network communications user and the third virtual network communications user simultaneously.

In some embodiments, the first virtual network communications user is a controller user, wherein the controller user can access the set of asset computation and control information, wherein the virtual network communications platform further generates a virtual representation of the asset computation and control information.

In some embodiments, asset computation and control information comprises the sorted aggregate data, wherein the sorted aggregate data further comprises user communication identifier information, asset valuation data, asset computation and control organization valuation data, asset specification, asset condition information, asset environment data.

In some embodiments, a method is provided for virtual computation and control of assets by aggregating disparate data received from disparate data systems in a complex computing network. The method for virtual computation and control of assets may be used by an asset computation and control organization for controlling asset information and network communications. method comprises: establishing a first connection from a hardware data communication interface to a first input data system, the first input data system being associated with a first set of geographical data, the first set of geographical data being based on a first location; receiving the first set of geographical data on the first connection; establishing a second connection to a second input signal system, the second input data system being associated with a second set of geographical data, the second set of geographical data being based on a second location; receiving the second set of geographical data on the second connection; receiving identifying information for the first location and for the second location; using a hardware digital processor, analyzing the first set of geographical data and the second set of geographical data; using the hardware digital processor, charting the first location and the second location based on the identifying information to create a first location identifier and a second location identifier; using the hardware digital processor, aggregating the first set of geographical data and the second set of geographical data to create an aggregate set of data; using the hardware digital processor, sorting the aggregate data into the first location identifier and the second location identifier; and using a hardware user interface, a first user accessing the hardware user interface; using the hardware user interface, receiving the sorted aggregate data, the first location identifier, and the second location identifier; using the hardware user interface, the first user accessing sorted aggregate data, wherein the first user is able to view if the sorted aggregate data is sorted into the first location identifier or the second location identifier; and the hardware user interface generates a virtual representation of the first location or the second location.

The present disclosure provides several important technical advantages that will be readily apparent to one skilled in the art from the figures, descriptions, and claims. Moreover, while specific advantages have been enumerated above, various embodiments may include all, some, or none of the enumerated advantages. Any sentence or statement in this disclosure may be associated with one or more embodiments.

For the purposes of the specification, the term “virtual” may be online, digital, electronic, by way of a computer network, etc. Accordingly, in some embodiments, virtual networks or systems may be online networks, digital systems, electronic networks, computing network systems, etc. Assets, in some embodiments may be online property, digital property, electronic property, personal property, real property such as single-family homes, semi-detached homes, multi-family homes, townhomes, apartments, or condominiums, etc. In some embodiments, “computation and control” may be analysis, organization, management, calculation, administration, etc.

Any embodiments, described herein can be combined with any other embodiments described herein or can be combined with embodiments described in patent applications or patents incorporated by reference herein.

Although similar reference numbers may be used to refer to similar elements for convenience, it can be appreciated that each of the various example embodiments may be considered to be distinct variations. As used in this disclosure, the terms “embodiment” and “example embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only, and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

In some embodiments, the virtual computation and control system may enable a user to engage in a variety of neighborhood or homeowners' association (“HOA”) functions, including accessing documentation, reserving amenities, parking spots, or locations, paying dues or fees, attending virtual meetings, requesting maintenance, requesting vendor assistance, submitting requests, etc.

In some embodiments, a user may be able to create a profile or page related to them or any property or assets associated with them. These profiles may include personal information, personal characteristics, characterizes about a property or asset, interests, etc.

In some embodiments, the virtual computation and control system may have an associated management user. The management user may be associated solely with a location or neighborhood, or may be associated with an HOA or other organization. The management user may serve a variety of functions or services related to a community, neighborhood, or HOA. These functions or services may include social coordination, mediation, vendor or contraction communication, negotiation, and selection, serving as a human responder, communication, organization of events or initiatives, financial management, management of a community, neighborhood or HOA board, etc.

In some embodiments, the management user may be supplemented or replaced by an AI or virtual management user.

In some embodiments, the virtual computation and control system may have an associated virtual network communications platform. The virtual network communication platform may enable users to partake in virtual reality or augmented reality environments, These virtual reality or augmented reality environments may represent real world locations, areas, or buildings. Locations, areas, or buildings may be representative of corresponding aspects of neighborhoods, communities, or HOAs. Multiple users or neighbors may be able to meet or interact with one another. Users may attend meetings or meet in virtual locations. A user may be able to access documents or information about communities, neighborhoods, or HOAs within virtual locations. Virtual locations may leverage real world feeds or information to combine elements of both.

In some embodiments, a user may be able to perform home functions by using the virtual computation and control system or virtual network communications platform. These home functions may help with day to day living needs, and may include organizing repairs, setting up utility services, connecting to different locations, ordering food or deliveries, interacting with HOAs, etc.

In some embodiments, the virtual computation and control system or virtual network communications platform may be leveraged to improve safety in a neighborhood or community. The virtual computation and control system or virtual network communications platform may be linked to crime monitoring systems or organizations, or may link to video feeds set up in relevant areas. Instances of crimes may be recorded and leveraged to provide more detailed information and statistics for an associated neighborhood, community, or HOA.

In some embodiments, the virtual computation and control system or virtual network communications platform may aggregate data based on neighborhoods, communities, or HOAs from across the country. This data may be analyzed to compare and create profiles for different neighborhoods, communities, or HOAs, that a user may be able to view. A user may be able to sort neighborhoods, communities, or HOAs based on data and statistics on the data. Data may be related to property values, services and benefits of different communities, crime statistics, amenities, property taxes, school districts, neighbor profiles, etc. This data may be aggregated from a variety of national and local sources and inputs.

In some embodiments, data may be retrieved from social media websites, or may be retrieved from housing and community related websites. In some embodiments, data may be input directly from users or other participants.

In some embodiments, the virtual computation and control system or virtual network communications platform may provide mews or updates based on occurrences in a neighborhood, community, or HOA.

In some embodiments, the virtual computation and control system may leverage machine learning or artificial intelligence. Machine learning or artificial intelligence may derive data, observations, or trends based on geographic data that is input or collected from other sources.

In some embodiments, geographic data or information may include information about locations, neighborhoods, homes, houses, communities, environmental data, longitudal and/or latitudal positons, geographical formations or features, landmarks, destinations, or details or statistics about any of the above, etc.

In some embodiments, “asset” may refer to a variety of both digital and physical assets. Physical assets may include real property, real estate, houses, living communities, locations, deeds, etc. “Service” may refer to facilities or functions that relate to an asset. Facilities or functions may include payment or distribution of funds related to an asset, amenities or features of a community or organization, management of community services or jobs, communication with members of a community, etc. “Asset management organization” may refer to organizations that assist with the management, control, and administration of a community, such as a homeowners' association (“HOA”). Information relating to an HOA or any other geographical information or data, may be referred to in the specification generally as “information.” A “management user” may be an administrator or executive who assists in the operation and running of an HOA or community. “Network communications” may refer to any communications that occur over a network, including meetings, messages, emails, etc. A “virtual network communications platform” or “communications platform” may refer to any communication platform that is hosted digitally, including interactions in virtual reality, a virtual environment, or the metaverse. A “user communications platform” may refer to any communications platform that can be accessed by a user, including social media platforms and platforms specific to a given community or organization. “Computation and control” may refer to the computation and control of an asset, where computation and control can include management or organizational activities related to a neighborhood, community, or HOA. A “user” may refer to a member of community, a homeowner, a resident, etc. “Virtual” may refer to anything that is digitalized, simulated, or related to the rendering of virtual or augmented environments. “Charting” may refer to association of information with a location or may refer to visually mapping information based on geographic representations. “Sorting” may refer to sorting any information based on components of the information, including geographical components.

It is understood that any specific order or hierarchy of steps in the processes disclosed is an illustration of example approaches. Based upon design preferences, it is understood that the specific order or hierarchy of steps in the processes may be rearranged, or that all illustrated steps be performed, or that some illustrated steps not be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network.

“Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. An apparatus for aggregation of disparate data received from disparate data systems in a complex computing network for establishing a virtual computation and control system associated with and utilizing the aggregated disparate data, the aggregation, processing, and generating of visual representations necessarily rooted in computing technology, the apparatus comprising:
a hardware data communication interface for:
establishing a first connection to a first input data system, the first input data system being associated with a first set of geographical data, the first set of geographical data being based on a first location;
receiving the first set of geographical data on the first connection;
establishing a second connection to a second input data system, the second input data system being associated with a second set of geographical data, the second set of geographical data being based on a second location;
receiving the second set of geographical data on the second connection;
receiving a first identifying information for the first location and a second identifying information for the second location;
a hardware digital data processor for;
analyzing the first set of geographical data and the second set of geographical data;
charting the first location and the second location based on the first identifying information and the second identifying information to create a first location identifier and a second location identifier;
aggregating the first set of geographical data and the second set of geographical data to create an aggregate set of data;
categorizing the aggregate set of data into the first location identifier and the second identifier; and
a hardware user interface, wherein:
a first user accesses the hardware user interface;
the hardware user interface receives the aggregate set of data, the first location identifier, and the second location identifier,
the first user accesses the aggregate set of data, wherein the first user is able to view whether the aggregate set of data is sorted into the first location identifier or the second location identifier;
the hardware user interface generates a representation of the first location or the second location; and
the hardware user interface adjusts the virtual representation of the first location or the second location based on a data request from the first user.

2. The apparatus according to claim 1, wherein the hardware user interface comprises a mobile electronic device.

3. The apparatus according to claim 1, wherein the first connection is established over an intranet.

4. The apparatus according to claim 1, wherein the hardware user interface comprises a virtual machine and the representation is a virtual representation.

5. The apparatus according to claim 1, wherein the hardware data communication interface comprises a storage logic that is executable to store structured data.

6. The apparatus according to claim 1, wherein the first set of geographical data comprises at least one of structured data, user interface data, user device information, image data, text data, audio data, video data, and document data.

7. The apparatus according to claim 1, wherein the hardware digital processor comprises a graphical processing subsystem enabled to generate, modify, analyze, process, transmit, or present data.

8. The apparatus according to claim 1, wherein the hardware digital processor comprises an encryption engine enable to translate, encrypt, decrypt, encode, or decode data.

9. The apparatus according to claim 1, wherein the hardware data communication interface comprises a virtual computation and control system that is enabled to moderate network communications.

10. The apparatus according to claim 1, wherein the hardware user interface is enabled to communicate with a second hardware user interface comprising a user communications platform.

11. An apparatus for aggregation of disparate data received from disparate data systems in a complex computing network for establishing a virtual computation and control system associated with and utilizing the aggregated disparate data, the aggregation, processing, and generating of digital platforms necessarily rooted in computing technology, the digital platforms serving as interaction points for a user, the apparatus comprising:
a hardware data communication interface for:
establishing a first connection to a first input data system, the first input data system being associated with a first set of geographical data, the first set of geographical data being based on a first location;
receiving the first set of geographical data on the first connection;
establishing a second connection to a second input data system, the second input data system being associated with a second set of geographical data, the second set of geographical data being based on a second location;
receiving the second set of geographical data on the second connection;
receiving first identifying information for the first location and second identifying information for the second location;
a hardware digital data processor for:
analysing the first set of geographical data and the second set of geographical data;
charting the first location and the second location based on the first identifying information and the second identifying information to create a first location identifier and a second location identifier;
aggregating the first set of geographical data and the second set of geographical data to create an aggregate set of data;
categorizing the aggregate set of data into the first location identifier and the second identifier; and
a hardware user interface, wherein:
a first user accesses the hardware user interface;
the hardware user interface receives the aggregate set of data, the first location identifier, and the second location identifier,
the first user accesses the aggregate set of data, wherein the first user is able to view whether the aggregate set of data is sorted into the first location identifier or the second location identifier;
the hardware user interface generates a digital platform linked to the first location identifier or the second location identifier, wherein the digital platform displays a variety of icons related to the first location or the second location; and
the hardware user interface receives an input from the first user, wherein the first user supplements the sorted aggregate data;
the hardware user interface adjusts the sorted aggregate data based on the input; an
the hardware user interface regenerates the variety of icons based on the adjustment of the sorted aggregate data.

12. The apparatus according to claim 11, wherein the hardware user interface comprises a mobile electronic device.

13. The apparatus according to claim 11, wherein the first connection is established over an intranet.

14. The apparatus according to claim 11, wherein the hardware user interface comprises a virtual machine and the representation is a virtual representation.

15. The apparatus according to claim 11, wherein the hardware data communication interface comprises a storage logic that is executable to store structured data.

16. The apparatus according to claim 11, wherein the first set of geographical data comprises at least one of structured data, user interface data, user device information, image data, text data, audio data, video data, and document data.

17. The apparatus according to claim 11, wherein the hardware digital processor comprises a graphical processing subsystem enabled to generate, modify, analyze, process, transmit, or present data.

18. The apparatus according to claim 11, wherein the hardware digital processor comprises an encryption engine enable to translate, encrypt, decrypt, encode, or decode data.

19. The apparatus according to claim 11, wherein the hardware data communication interface comprises a virtual computation and control system that is enabled to moderate network communications.

20. The apparatus according to claim 11, wherein the hardware user interface is enabled to communicate with a second hardware user interface comprising a user communications platform.
